(19) United States
(12) Patent Application Publication
(10) Pub. No.: US 2014/0188605 A1
(43) Pub. Date: Jul. 3, 2014

(54) Techniques For Delivering A Product Promotion To A Consumer

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/729,904

(22) Filed: Dec. 28, 2012

(51) Int. Cl. G06Q 30/02

(52) U.S. Cl. CPC G06Q 30/0251
USPC 705/14.53; 705/14.69; 705/14.49

(57) ABSTRACT

A computer-implemented method is disclosed herein. The method includes the step of receiving, at a processing device of a commerce server, one or more signals from a head mountable unit corresponding to a forward direction and a position of the head mountable unit. The method also includes the step of identifying, with the processing device, at least one product that is in the forward direction of the head mountable unit based on the signal received from the head mountable unit. The method also includes the step of obtaining, with the processing device, at least one product promotion for the at least one product. The method also includes the step of transmitting, with the processing device, the at least one product promotion to the head mountable unit.

### BACKGROUND INFORMATION

1. Field of the Disclosure

The present invention relates generally to optimizing the delivery of product promotions to consumers. In particular, examples of the present invention are related to techniques for delivering product promotions to a consumer shopping in a retail store through a head mountable unit.

2. Background

Product promotions can be delivered in print, audio and video formats. A product promotion can be a sale, a coupon, a price rollback, or some other attribute of the product that increases the desirability of the product to a consumer. Many consumers collect coupons or search through sale announcements when preparing to shop for products such as groceries, office supplies, and household wares. However, many consumers do not collect coupons and therefore miss product promotions. Consumers that do collect coupons may spend significant time teeming through the coupons and sale announcements in an effort to find deals and ultimately reduce the amount of money spent on products. One drawback for the consumers, however, is that collecting coupons takes time and the coupons may not be readily accessible when the consumer visits a retail store unless the consumer is willing to carry the coupons at all times. The effectiveness of other kinds of product promotions can be similarly undermined for similar reasons.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating a head mountable unit that can be applied in some embodiments of the present disclosure.

FIG. 3 is an example block diagram illustration a commerce server that can be applied in some embodiments of the present disclosure.

FIG. 4A is an example screen shot of the display visible with the head mountable unit prior to receipt of a product promotion.

FIG. 4B is an example screen shot of the display visible with the head mountable unit prior after receipt of a product promotion.

FIG. 4C is another example screen shot of the display visible with the head mountable unit prior after receipt of a product promotion.

FIG. 5 is an example flow chart illustrating a method that can be carried out according to some embodiments of the present disclosure.

FIG. 6 is an example flow chart illustrating another method that can be carried out according to some embodiments of the present disclosure.

FIG. 7 is an example flow chart illustrating another method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

It can be desirable to deliver product promotions to a consumer while the consumer is shopping. A product promotion can be coupon and a price rollback. A product promotion can also be any other information that tends to induce a consumer to purchase the product, such as an attribute of the product or a consequence of purchase. For example, a product can be promoted based on the product being “organic.” A product can be promoted based on its place of origin, such as “locally grown.” A product can also be promoted based on the fact that a portion of the purchase price will be donated to a charity. The information that can be conveyed by a product promotion can improve the desirability of the product the consumer.

Embodiments of the present invention empower consumers by providing techniques for delivery product promotions while shopping. For example, a system according to an embodiment of the disclosure can include a commerce server receiving signals from an augmented reality device such as a head mountable unit worn by the consumer. The head mountable unit can transmit data corresponding to the position of the consumer within a retail store, the direction the customer is facing, and a video signal of the field of view of the consumer. This data, in conjunction with data related to the floor plan of the retail store and the locations of products within the retail store can be processed and analyzed by the commerce server to select appropriate product promotions. These product promotions can be transmitted to the head mountable unit and presented on a display of the augmented reality device that is visible to the consumer.

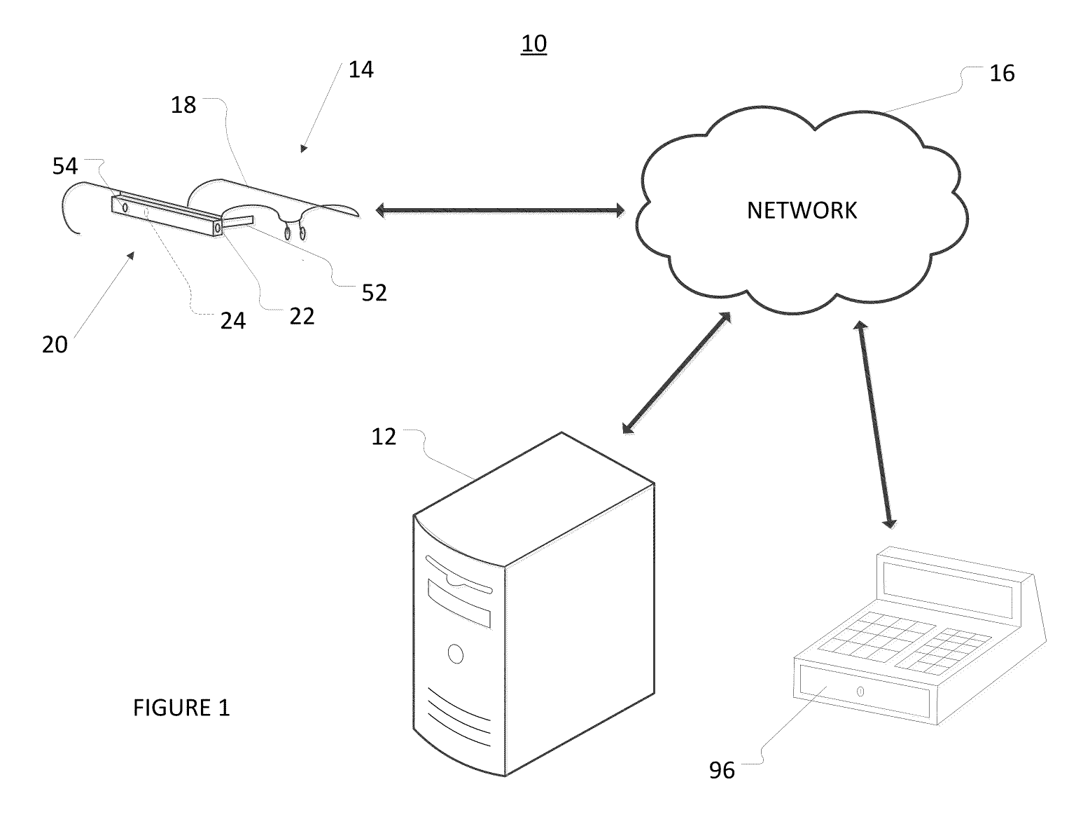

To illustrate, FIG. 1 is a schematic illustrating a product promotion system 10 according to some embodiments of the present disclosure. The product promotion system 10 can implement a computer-implemented method that includes the step of receiving, at a processing device of a commerce server 12, a first signal from a head mountable unit 14. The signal from the head mountable unit 14 and received by the commerce server 12 can be transmitted through a network 16. As used herein, the term “network” can include, but is not limited to, a Local Area Network (LAN), a Metropolitan Area Network (MAN), a Wide Area Network (WAN), the Internet, or combinations thereof.

The head mountable unit 14 can be worn by a consumer while moving within a retail store. In the illustrated embodiment of FIG. 1, the exemplary head mountable unit 14 includes a frame 18 and a communications unit 20 supported on the frame 18.

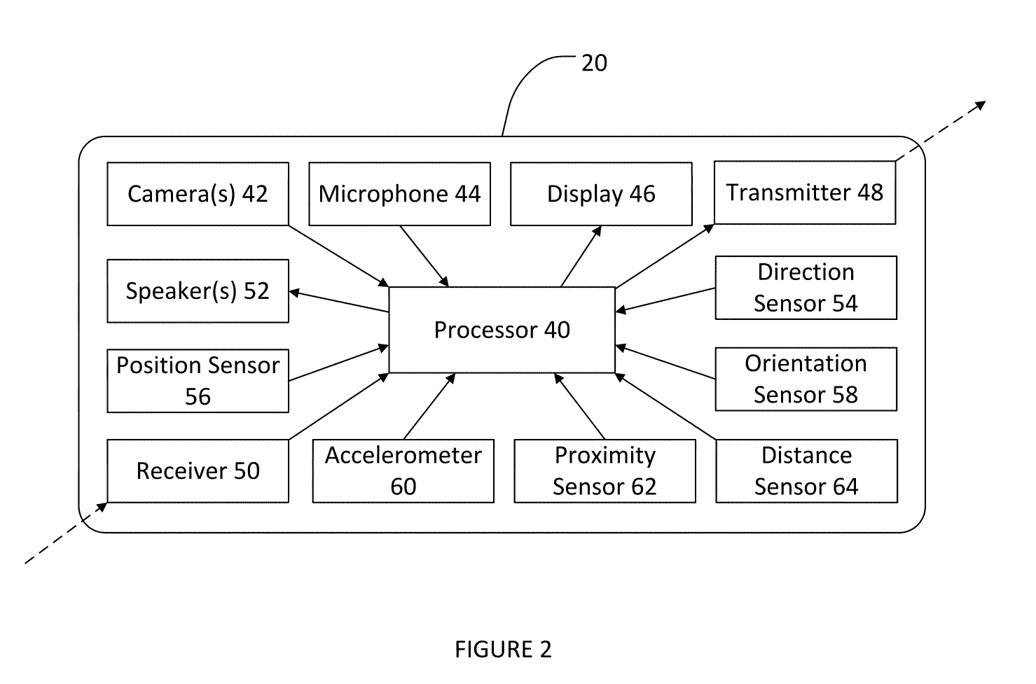

FIG. 2 is a block diagram illustrating exemplary components of the communications unit 20. The communications unit can include a processor 40, one or more cameras 42, a microphone 44, a display 46, a transmitter 48, a receiver 50, one or more speakers 52, a direction sensor 54, a position sensor 56, an orientation sensor 58, an accelerometer 60, a proximity sensor 62, and a distance sensor 64.

The processor 40 can be operable to receive signals generated by the other components of the communications unit 20. The processor 40 can also be operable to control the other components of the communications unit 20. The processor 40 can also be operable to process signals received by the head mount unit 14. While one processor 40 is illustrated, it should be appreciated that the term “processor” can include two or more processors that operate in an individual or distributed manner.

The head mount unit 14 can include one or more cameras 42. Each camera 42 can be configured to generate a video signal. One of the cameras 42 can be oriented to generate a video signal that approximates the field of view of the consumer wearing the head mountable unit 14. Each camera 42 can be operable to capture single images and/or video and to generate a video signal based thereon. The video signal may be representative of the field of view of the consumer wearing the head mountable unit 14.

In some embodiments of the disclosure, cameras 42 may be a plurality of forward-facing cameras 42. The cameras 42 can be a stereo camera with two or more lenses with a separate image sensor or film frame for each lens. This arrangement allows the camera to simulate human binocular vision and thus capture three-dimensional images. This process is known as stereo photography. The cameras 42 can be configured to execute computer stereo vision in which three-dimensional information is extracted from digital images. In such embodiments, the orientation of the cameras 42 can be known and the respective video signals can be processed to triangulate an object with both video signals. This processing can be applied to determine the distance that the consumer is spaced from the object. Determining the distance that the consumer is spaced from the object can be executed by the processor 40 or by the commerce server 12 using known distance calculation techniques.

Processing of the one or more, forward-facing video signals can also be applied to determine the identity of the object. Determining the identity of the object, such as the identity of a product in the retail store, can be executed by the processor 40 or by the commerce server 12. If the processing is executed by the commerce server 12, the processor 40 can modify the video signals limit the transmission of data back to the commerce server 12. For example, the video signal can be parsed and one or more image files can be transmitted to the commerce server 12 instead of a live video feed. Further, the video can be modified from color to black and white to further reduce transmission load and/or ease the burden of processing for either the processor 40 or the commerce server 12. Also, the video can cropped to an area of interest to reduce the transmission of data to the commerce server 12.

In some embodiments of the present disclosure, the cameras 42 can include one or more inwardly-facing camera 42 directed toward the consumer's eyes. A video signal revealing the consumer's eyes can be processed using eye tracking techniques to determine the direction that the consumer is viewing. In one example, a video signal from an inwardly-facing camera can be correlated with one or more forward-facing video signals to determine the object the consumer is viewing.

The microphone 44 can be configured to generate an audio signal that corresponds to sound generated by and/or proximate to the consumer. The audio signal can be processed by the processor 40 or by the commerce server 12. For example, verbal signals can be processed by the commerce server 12 such as “this product appears interesting.” Such audio signals can be correlated to the video recording.

The display 46 can be positioned within the consumer's field of view. Video content can be shown to the consumer with the display 46. The display 52 can be configured to display text, graphics, images, illustrations and any other video signals to the consumer. The display 46 can be transparent when not in use and partially transparent when in use to minimize the obstruction of the consumer's field of view through the display 46.

The transmitter 48 can be configured to transmit signals generated by the other components of the communications unit 20 from the head mountable unit 14. The processor 40 can direct signals generated by components of the communications unit 20 to the commerce sever 12 through the transmitter 48. The transmitter 48 can be an electrical communication element within the processor 40. In one example, the processor 40 is operable to direct the video and audio signals to the transmitter 40 and the transmitter 48 is operable to transmit the video signal and/or audio signal from the head mountable unit 14, such as to the commerce server 12 through the network 16.

The receiver 50 can be configured to receive signals and direct signals that are received to the processor 40 for further processing. The receiver 50 can be operable to receive transmissions from the network 16 and then communicate the transmissions to the processor 40. The receiver 50 can be an electrical communication element within the processor 40. In some embodiments of the present disclosure, the receiver 50 and the transmitter 48 can be an integral unit.

The transmitter 48 and receiver 50 can communicate over a Wi-Fi network, allowing the head mountable device 14 to exchange data wirelessly (using radio waves) over a computer network, including high-speed Internet connections. The transmitter 48 and receiver 50 can also apply Bluetooth® standards for exchanging data over short distances by using short-wavelength radio transmissions, and thus creating personal area network (PAN). The transmitter 48 and receiver 50 can also apply 3G or 4G, which is defined by the International Mobile Telecommunications-2000 (IMT-2000) specifications promulgated by the International Telecommunication Union.

The head mountable unit 14 can include one or more speakers 52. Each speaker 52 can be configured to emit sounds, messages, information, and any other audio signal to the consumer. The speaker 52 can be positioned within the consumer's range of hearing. Audio content transmitted by the commerce server 12 can be played for the consumer through the speaker 52. The receiver 50 can receive the audio signal from the commerce server 12 and direct the audio signal to the processor 40. The processor 40 can then control the speaker 52 to emit the audio content.

The direction sensor 54 can be configured to generate a direction signal that is indicative of the direction that the consumer is facing. The direction signal can be processed by the processor 40 or by the commerce server 12. For example, the direction sensor 54 can electrically communicate the direction signal containing direction data to the processor 40 and the processor 40 can control the transmitter 48 to transmit the direction signal to the commerce server 12 through the network 16. By way of example and not limitation, the direction signal can be useful in determining the identity of a product(s) visible in the video signal, as well as the location of the consumer within the retail store.

The direction sensor 54 can include a compass or another structure for deriving direction data. For example, the direction sensor 54 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit 14.

The position sensor 56 can be configured to generate a position signal indicative of the position of the consumer within the retail store. The position sensor 56 can be configured to detect an absolute or relative position of the consumer wearing the head mountable unit 14. The position sensor 56 can electrically communicate a position signal containing position data to the processor 40 and the processor 40 can control the transmitter 48 to transmit the position signal to the commerce server 12 through the network 16.

Identifying the position of the consumer can be accomplished by radio, ultrasound or ultrasonic, infrared, or any combination thereof. The position sensor 56 can be a component of a real-time locating system (RTLS), which is used to identify the location of objects and people in real time within a building such as a retail store. The position sensor 56 can include a tag that communicates with fixed reference points in the retail store. The fixed reference points can receive wireless signals from the position sensor 56. The position signal can be processed to assist in determining one or more products that are proximate to the consumer and are visible in the video signal.

The orientation sensor 58 can be configured to generate an orientation signal indicative of the orientation of the consumer's head, such as the extent to which the consumer is looking downward, upward, or parallel to the ground. A gyroscope can be a component of the orientation sensor 58. The orientation sensor 58 can generate the orientation signal in response to the orientation that is detected and communicate the orientation signal to the processor 40. The orientation of the consumer's head can indicate whether the consumer is viewing a lower shelf, an upper shelf, or a middle shelf.

The accelerometer 60 can be configured to generate an acceleration signal indicative of the motion of the consumer. The acceleration signal can be processed to assist in determining if the consumer has slowed or stopped, tending to indicate that the consumer is evaluating one or more products for purchase. The accelerometer 60 can be a sensor that is operable to detect the motion of the consumer wearing the head mountable unit 14. The accelerometer 60 can generate a signal based on the movement that is detected and communicate the signal to the processor 40. The motion that is detected can be the acceleration of the consumer and the processor 40 can derive the velocity of the consumer from the acceleration. Alternatively, the commerce server 12 can process the acceleration signal to derive the velocity and acceleration of the consumer in the retail store.

The proximity sensor 62 can be operable to detect the presence of nearby objects without any physical contact. The proximity sensor 62 can apply an electromagnetic field or a beam of electromagnetic radiation such infrared and assess changes in the field or in the return signal. Alternatively, the proximity sensor 62 can apply capacitive photoelectric principles or induction. The proximity sensor 62 can generate a proximity signal and communicate the proximity signal to the processor 40. The proximity sensor 62 can be useful in determining when a consumer has grasped and is inspecting a product.

The distance sensor 64 can be operable to detect a distance between an object and the head mountable unit 14. The distance sensor 64 can generate a distance signal and communicate the signal to the processor 40. The distance sensor 64 can apply a laser to determine distance. The direction of the laser can be aligned with the direction that the consumer is facing. The distance signal can be useful in determining the distance to an object in the video signal generated by one of the cameras 42, which can be useful in determining the consumer's location in the retail store.

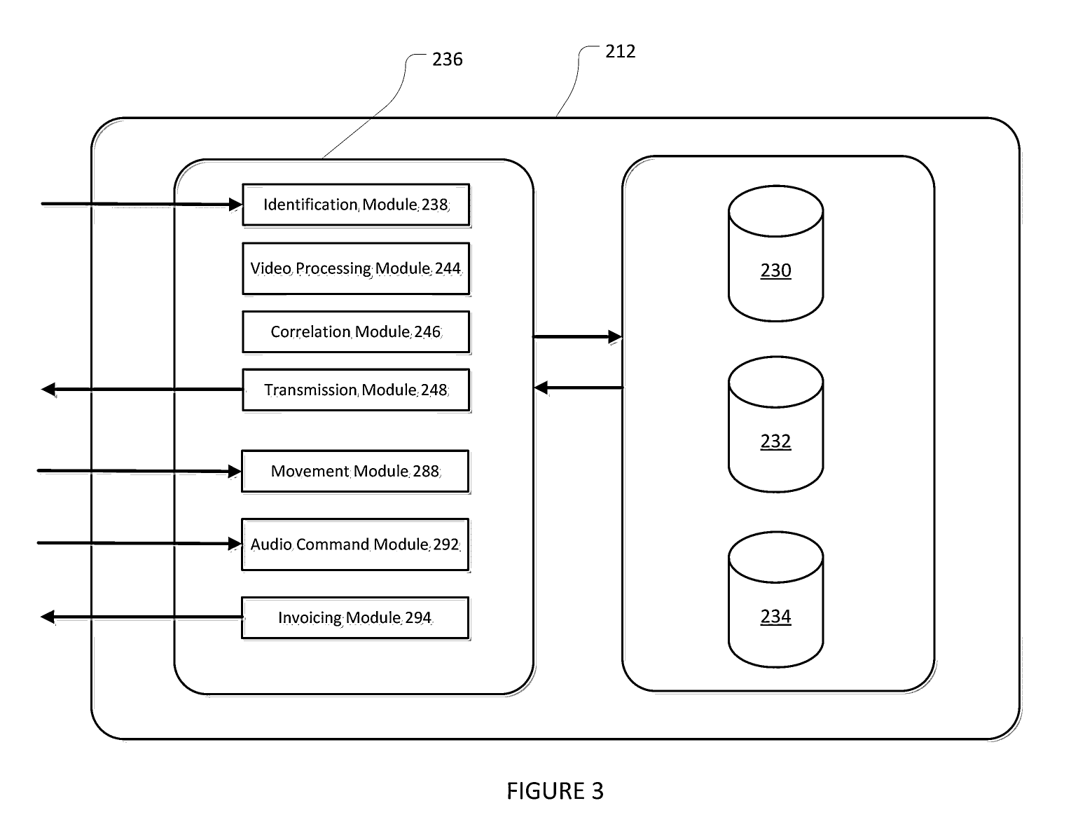

FIG. 3 is a block diagram illustrating a commerce server 212 according to some embodiments of the present disclosure. In the illustrated embodiment, the commerce server 212 can include a product database 230, a promotion database 232, and a customer purchase history database 234. The commerce server 212 can also include a processing device 236 configured to include an identification module 238, a video processing module 244, a correlation module 246, a transmission module 248, a movement module 288, an audio command module 292, and an invoicing module 294.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The product database 230 can include memory containing the identities of a plurality of products. The plurality of products can be the products offered for sale in a retail store associated with the commerce server 212. The product database 230 can also contain a floor plan of the retail store, including the location of each of the plurality of products within the retail store. The data in the promotion database 232 can be organized based on one or more tables that may utilize one or more algorithms and/or indexes.

The promotion database 232 can include memory containing product promotions associated with one or more of the plurality of products. The product promotions can be defined by video data, audio data, and/or text data. The product promotions can be located within the promotion database 232 and can be organized based on one or more tables that may utilize one or more algorithms and/or indexes.

The consumer purchase history database 234 can include memory containing purchase histories of consumers, such as a purchase history of the consumer wearing the head mountable unit 14. The data in the consumer purchase history database 234 can be organized based on one or more tables that may utilize one or more algorithms and/or indexes.

The processing device 236 can communicate with the databases 230, 232, 234. The processing device 236 can include computer readable memory storing computer readable instructions and one or more processors executing the computer readable instructions. The processing device 236 can include an identification module 238 operable to receive a signal from the head mountable unit 14. The orientation signal can be initially generated by the direction sensor 54 and transmitted by the head mountable unit 14 to the identification module 238. The orientation signal can correspond to a forward-facing direction of the consumer. The identification module 238 can also receive the position signal from the head mountable unit 14. The position signal can be generated by the position sensor 56 and contain data corresponding to a location of the head mountable unit 14 in the retail store. The orientation and position signals can be received consecutively or concurrently by the processing device 236.

The identification module 238 can be operable to identify at least one of the plurality of products within the retail store that is in the forward-facing direction of the head mountable unit 14. The data associated with the orientation and position signals and the data in the product database 230 can be correlated by the identification module 238 to more precisely narrow down the products being considered for purchase by the consumer.

The identification module 238 can further narrow the set of possible products to identified product(s) based on the proximity of products to the head mountable unit 14. Proximate products can be products immediately in front of the consumer or, products within the field of view of the consumer. Products outside of this range, but forward of the head mountable unit 14, can be dismissed by the identification module 238. For example, products that are in adjacent aisles or further away can be dismissed by the identification module 238.

In some embodiments, the identification module 238 can receive signals corresponding to additional data from the head mountable unit 14. For example, the identification module 238 can receive a video signal from the camera 42 of the head mountable unit 14. The processing device 236 can also include a video processing module 244 operable to analyze the video signal received from the head mountable unit 14. The product database 230 can also include image data associated with each of the plurality of products in the retail store and the video processing module 244 can implement known video recognition/analysis techniques and algorithms to identify a product in the shown in the video signal received from the head mountable unit. This feature of some embodiments of the present disclosure can refine the identification of the product being considered for purchase by the customer.

The processing device 36 can also include a correlation module 246 operable to correlate each of the one or more products identified by the identification module 238 with at least one product promotion in the promotion database 232. The correlation module 246 can correlate a specific product that has been identified to one or more specific product promotions contained in the promotion database 232. For example, if the consumer is viewing a beverage offered for sale, the correlation module 246 can correlate the beverage with a coupon for that beverage. Alternatively, the correlation module 246 can correlate a specific product to promotions for related products. For example, the correlation module 246 can correlate the beverage being viewed by the consumer with a coupon for that beverage, a coupon for a first competing beverage, a notice that a second competing beverage is produced locally, and a notice that a third competing beverage is the healthiest beverage in its class.

The correlation module 246 can also correlate the specific product with product promotions based on the location of products within the retail store. In some embodiments of the present disclosure, if the consumer is viewing a beverage offered for sale, the correlation module 246 can correlate the beverage with a coupon for a food product disposed on the same shelf and adjacent to the beverage. For example, if the identification module 238 has determined that the consumer is considering the purchase of tortilla chips, the correlation module 246 determine that the appropriate product promotions include at least a first product promotion for tortilla chips and a second product promotion for salsa.

The processing device 236 can also include a transmission module 248 operable to receive one or more correlated product promotions from the correlation module 246 and transmit the one or more of product promotions to the head mountable unit 14. The signal from the transmission module 248 can be received by a receiver 50 of the communication unit 20. The receiver 50 can electrically communicate the one or more product promotions to the processor 40.

The product promotion that is transmitted to the head mountable unit 14 can be a form of electronic file that includes video, audio, graphic, and/or text data. The processor 40 can receive the signal from the transmission module 48 and display the product promotion through the display 46 and/or through a speaker 52.

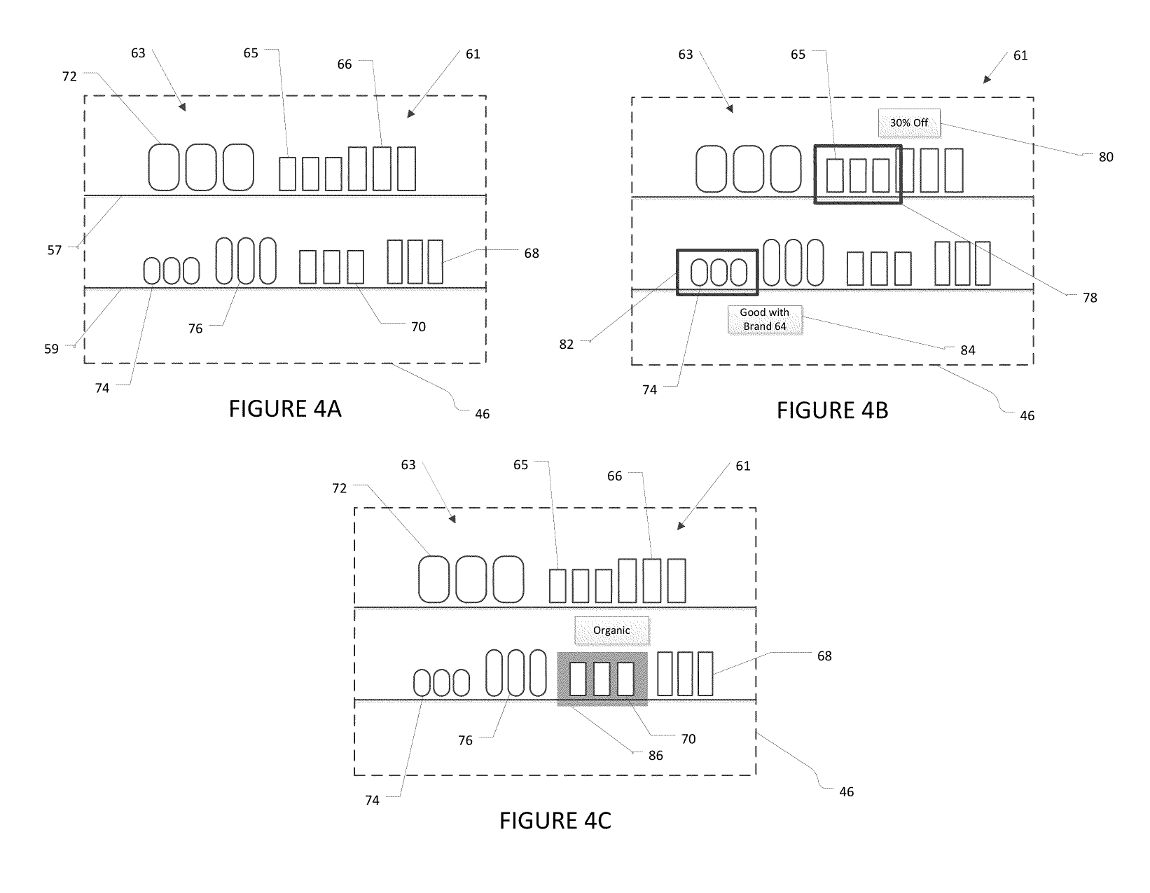

FIGS. 4A-4C illustrate views that can be perceived by the consumer in some embodiments of the present disclosure. FIG. 4A is a screen shot of a field of view that can be visible to the consumer. The screen shot can fill the display 46 or can be a portion of the display 46. The consumer can be looking through at least part of the display 46, such as to view shelves 57, 59 supporting two categories 61, 63 of products. Category 61 includes four different brands 65, 66, 68, 70 available for purchase and category 63 includes three brands 72, 74, 76. FIG. 4A illustrates a screen shot visible to a consumer wearing the head mountable unit 14 prior to the receipt of a product promotion.

The camera 42 and display 46 can be generally aligned such that display 46 overlaps the field of view of the camera 42. In other words, the camera 42 is arranged so that the video signal received by the commerce server 212 is substantially similar to the field of view of the consumer wearing the head mountable unit 14. Based on the direction the consumer is facing, the position of the consumer in the retail store, and the video data obtained by the camera 42 (this data can correspond to the display shown in FIG. 4A), the identification module 238 can identify the category of product that the consumer is interested in purchasing. For example, the identification module 238 can identify the category 61 as the product that the consumer is considering for purchase since more brands of category 61 are in the field of view, compared to category 63. Alternatively, the identification module 238 can identify both categories 61 and 63 as being of interest to the consumer. Alternatively, instead of identifying a category, in some embodiments the identification module 238 can identify the brand at the center of the screen as the product of interest.

In one example, the identification module 238 can identify the category 61 as the product the consumer is considering for purchase. The correlation module 246 can then correlate one or more of the brands 65, 66, 68, 70 with one or more product promotions stored in the promotion database 232. The correlation module 246 can select one or more of the product promotions from the promotion database 232 correlated to the identified brands 65, 66, 68, 70. The transmission module 248 can transmit a signal to the head mountable unit 14 containing the product promotion(s).

The processor 40 of the head mountable unit 14 can receive the signal from the transmission module 248 through the receiver 50 and control the display 46 to change. FIG. 4B illustrates a visual display associated with a product promotion that has been generated on the display screen 52. The exemplary visual display is an outline referenced at 78 around the product brand 65, as well as text referenced at 80.

In some embodiments, product promotions can be displayed for all or less than all of the brands 65, 66, 68, 70. The promotions can be sized differently from one another; product manufacturers can pay for the opportunity of the largest product promotion display. The product promotions can be shaped differently from one another; product manufacturers can pay for particular promotion shapes or colors. Other types of displays can be applied in some embodiments of the present disclosure. For example, the outline 78 shown in FIG. 4B can be flashing.

In the example above, the identification module 238 determined the category 61 as the kind of product that the consumer is interested in purchasing. However, product promotions for can also be displayed on products not in category 61. FIG. 4B illustrates a second promotion displayed around brand 74 of category 63. The exemplary visual display is an outline referenced at 82 around the product brand 74, as well as text referenced at 84. In some embodiments, the categories 61 and 63 can be complementary.

In some embodiments, the identification module 238 can identify the brand 70 as the product the consumer is interested in purchasing. FIG. 4C illustrates a visual product promotion in the form of a highlight referenced at 86. The product promotion information regarding the brand 70 can be communicated with audio emitted through the speaker 52 of the head mountable unit. For example, an audio message such as “this product is organic” can be emitted through a speaker 52 as the highlight 86 is visible.

In some embodiments of the invention, it can be desirable to selectively transmit product promotions so that the promotions do not decrease the likelihood that the consumer will make a purchase. In some embodiments, product promotions are not transmitted until the processing device 236 establishes that the consumer has stopped moving, has slowed, or has remained in a predetermined area of the retail store for a predetermined period of time.

The processing device 236 can include a movement module 288. The movement module 288 can receive the acceleration signal from the head mountable unit 14 corresponding to movement of the consumer about the retail store. The accelerometer 60 can electrically communicate the acceleration signal containing acceleration data to the processor 40 and the processor 40 can control the transmitter 48 to transmit the acceleration signal to the commerce server 212 through the network 16. Other aspects of movement can be sensed and communicated to the processing device 236, such as velocity. In some embodiments, the position data generated by the position sensor 56 can be processed to determine the consumer's movement. The transmission of product promotions to the head mountable unit 14 can be held until the movement module 288 determines that the consumer has substantially stopped moving, indicating that the consumer has reached a product of interest.

The consumer can be viewed as substantially stopped when the head mountable unit 14 has fully stopped moving for some predetermined period of time. The predetermined period of time can be three seconds, five seconds, ten seconds, or some other length of time. Alternatively, the head mountable unit 14 can be viewed as substantially stopped when the consumer has remained in a single aisle of the retail store for the predetermined period time or has traversed back-and-forth over a predetermined range of an aisle. In some embodiments of the present disclosure, when this occurs, it is likely that the consumer has located the aisle containing a product for purchase.

In some embodiments, transmission of product promotions to the head mountable unit 14 can be held until an audio command is received by the processing device 236. The processing device 236 can execute an audio command or voice recognition module 292. The microphone 44 of the head mountable unit 14 can receive audio signals that can then be transmitted to the processing device 236. The voice recognition module 292 can implement known speech recognition techniques to identify speech in the audio signal, such as a voice command to transmit product promotions. The transmission module 248 can be configured to hold product promotions to the head mountable unit 14 until the consumer audibly indicates promotions are desired.

In some embodiments of the present disclosure, a product promotion can be temporary or conditional. For example, the product promotion can be a coupon available only if the consumer at least provisionally chooses to purchase the product. Video data received by the video processing module 44 can be analyzed using known image processing techniques and algorithms to determine if a product is being held by the consumer and/or if the product is placed in a basket or shopping cart. The consumer holding the product can be viewed as at least provisionally deciding to purchase the product. The consumer placing the product in a shopping cart can be viewed similarly or can be viewed as decision that merits a more significant product promotion, such as a greater value coupon.

If the consumer grasps the product or places the product in a shopping cart, the processing device 236 can communicate with a checkout station, referenced schematically at 96 in FIG. 1. When the consumer completes the purchase at the checkout station 96, the checkout station 96 can credit the consumer the amount of the coupon(s) that was accepted by the consumer.

The various promotions shown in FIGS. 4B and 4C, while a product is on a shelf, can be supplemented or replaced if the consumer takes hold of one of the products. The initial product promotion, or impression, can prompt the consumer to consider the product more closely and grasp the product. If the video processing module 244 determines that the product is being held by the consumer, the transmission module 248 can transmit a second product promotion of the product. For example, the first product promotion can advise the consumer that the product is produced locally and the second product promotion can be coupon that will be granted if the product is purchased. Alternatively, the first product promotion can be weekly special indicating that the price of the product is currently reduced and the second product promotion can disclose to the consumer that the product is the healthiest brand in the product category.

Embodiments of the invention can be practiced in which manufacturers are charged for the display of product promotions and charged different amounts for different promotions. The promotions as shown in FIGS. 4B and 4C can be viewed as a first level promotion. Promotions that are displayed when the consumer is holding the product can be viewed as a second price level of promotion.

The processing device 236 can include an invoicing module 294. Upon the transmission module 248 sending the second signal to display promotions such as shown in FIG. 4B or 4C, the invoicing module 294 can generate a first invoice for the manufacturer of the products of brands 65, 74, 70 for a first amount. If the consumer picks up any one of the products of brands 65, 74, 70, the invoicing module 294 can produce a second invoice for the manufacturer that product/brand for a second amount that is greater than the first amount.

In other embodiments of the present disclosure, the correlation module 246 can be operable to correlate based on the purchase history of the consumer wearing the head mountable unit 14. The processing device 236 can identify the head mountable unit 14 as being associated with a particular consumer. Upon this identification, the correlation module 246 can access the customer purchase history database 234. An exemplary promotion can be advising the consumer that the promoted product has been purchased before and identify when the product was purchased.

It is noted that the various processing functions set forth above can be executed differently than described above in order to enhance the efficiency of an embodiment of the present disclosure in a particular operating environment. The processor 40 can assume a greater role in processing some of the signals in some embodiments of the invention. For example, in some embodiments, the processor 40 on the head mountable unit 14 could modify the video stream to require less bandwidth. The processor 40 could convert a video signal containing color to black and white in order to reduce the bandwidth required for transmitting the video signal. In some embodiments, the processor 40 could crop the video, or sample the video and display frames of interest. A frame of interest could be a frame that is significantly different from other frames, such as a generally low quality video having an occasional high quality frame. Thus, in some embodiments, the processor 40 could selectively extract video or data of interest from a video signal containing data of interest and other data. Further, the processor 40 could process audio signals received through the microphone 44, such signals corresponding to audible commands from the consumer.

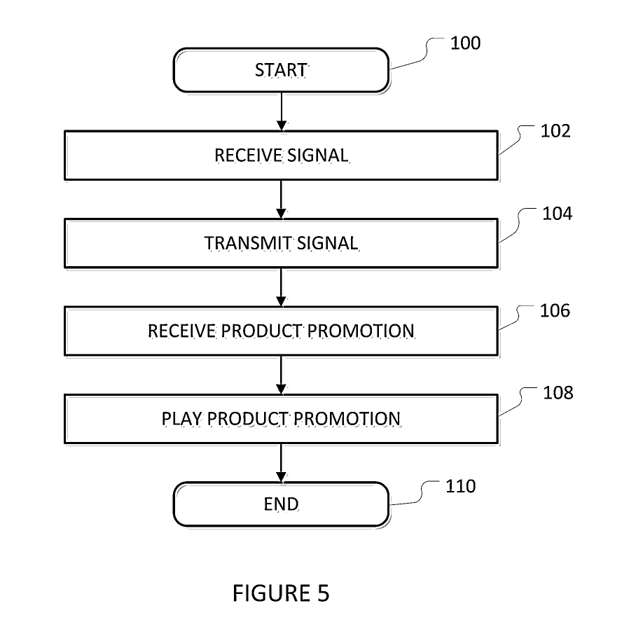

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The exemplary method shown in FIG. 5 can be executed by a processor of a head mountable unit. The method starts at step 100. At step 102, the processor can receive a signal. The signal can be an audio signal or a video signal or a signal that includes both audio and video data. The signal can be any signal that can be at least partially indicative of a product that is being considered for purchase by the consumer, the wearer of head mountable unit.

At step 104, the processor can transmit the signal. The processor can transmit the signal over a network. The processor can at least partially process the signal or transmit the signal directly. For example, the processor can be configured to convert an analog signal to a digital signal prior to transmission or can transmit the analog signal.

At step 106, the processor can receive a product promotion based on the signal transmitted at step 102. For example, if the signal received at step 102 and transmitted at step 104 indicates that the consumer is interested in a particular product, the product promotion received at step 106 can be for that product.

At step 108, the processor can control a display and/or speaker of the head mountable unit to play the product promotion. The product promotion can be an image or a video. The product promotion can be an audio message or can be the combination of audio and video. The exemplary method ends at step 110.

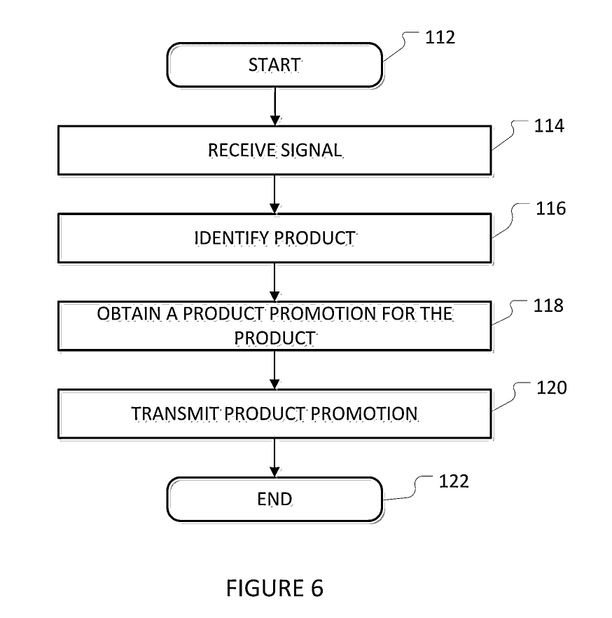

FIG. 6 is a flow chart illustrating a method that can be carried out in some embodiments of the present disclosure. The method can be executed by a commerce server. The commerce server can be located at the retail store or can be remote from the retail store. The method starts at step 112. At step 114, the commerce server can receive a signal. The signal can be indicative of the forward direction and location of a consumer in a retail store.

At step 116, at least one product that is in the retail store and is in the forward direction of the consumer is identified based on the signal received at step 114. At step 118, a product promotion can be obtained based on the product(s) identified at step 116. The product promotion can include any information tending to increase the likelihood that the product will be purchased. At step 120, the product promotion can be transmitted and the exemplary method ends at step 122.

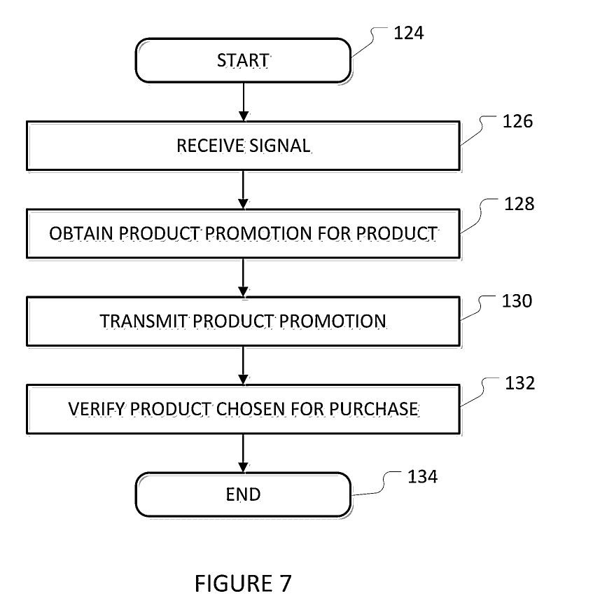

FIG. 7 is a flow chart illustrating a method that can be carried out in some embodiments of the present disclosure. The method can be executed by a commerce server. The commerce server can be located at the retail store or can be remote from the retail store. The method starts at step 124. At step 126, the commerce server can receive a signal. The signal can be indicative of a product being considered for purchase by a consumer in a retail store.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

At step 128, a product promotion can be obtained based on the product indicated by the signal in step 116. The product promotion can include any information tending to increase the likelihood that the product will be purchased. At step 130, the product promotion can be transmitted.

At step 132, the fact that the product has been chosen for purchase is verified. In some embodiments, it can be determined that the product has been at least provisionally elected for purchase. For example, some embodiments can verify by analyzing a video signal received from the head mountable unit 14. The video signal can indicate that the product has been grasped by the consumer and/or has been placed in a basket or shopping cart. The exemplary method ends at step 134.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A method comprising:
promoting a product manufactured by a manufacturer as a consumer is viewing the product in a retail store through an augmented reality device with a processing device of a commerce server; and
asserting a charge to the manufacturer with the processing device in response to said promoting step.

2. The method of claim 1 wherein said promoting step comprises:
promoting, with the processing device, the product as the consumer is viewing the product on a shelf in the retail store with a first product promotion electronically communicated to the augmented reality device.

3. The method of claim 2 wherein said promoting step comprises:
promoting, with the processing device, the product through a video display visible on a display of the augmented reality device.

4. The method of claim 2 wherein said promoting step comprises:
promoting, with the processing device, the product through an audible sound emission on a speaker of the augmented reality device.

5. The method of claim 2 wherein said promoting step comprises:
promoting, with the processing device, the product with a second product promotion as the consumer is holding the product wherein the second product promotion is different from the first product promotion.

6. The method of claim 5 wherein said asserting step comprises:
assigning, with the processing device, a first charge to the manufacturer for the first product promotion; and
assigning, with the processing device, a second charge to the manufacturer for the second product promotion, wherein the first and second charges are different from one another.

7. The method of claim 1 further comprising:
positioning the product in a retail store prior to said promoting step.

8. A method comprising:
positioning a product for sale in a retail store;
detecting consumer interest in purchasing the product with a processing device of a commerce server and an augmented reality device possessed by the consumer;
promoting the product when consumer interest is detected by the processing device with one of video data and audio data communicated through the augmented reality device; and
generating, with the processing device, an invoice to the manufacturer with the processing device in response to said promoting step.

9. The method of claim 8 wherein said detecting step further comprises:
electronically defining more than one level of consumer interest with the processing device; and
determining, with the processing device, the level of consumer interest in the product prior to said promoting step.

10. The method of claim 9 wherein said generating step further comprising:
generating an invoice to the manufacturer with the processing device in response to the level of consumer determined in said determining step.

11. The method of claim 9 wherein said promoting step further comprises:
selecting, with the processing device, a product promotion from a plurality of product promotions contained in a database in response to the level of consumer determined in said determining step.

12. The method of claim 8 wherein said detecting step further comprises:
detecting, with the processing device, consumer interest in purchasing the product only when the product is proximate to and directly in front of the consumer.

13. The method of claim 8 wherein said detecting step further comprises:
detecting, with the processing device, consumer interest in purchasing the product only when the product is proximate to the consumer.

14. The method of claim 8 further comprising:
applying, with the processing device, a purchase history of the consumer in executing said promoting step.

15. The method of claim 8 wherein said promoting step further comprises:
transmitting, with the processing device, first and second product promotions, different from one another and sequentially, to the consumer as the consumer is considering purchasing the first product.

16. A method comprising:
maintaining a product database of the identities and locations of products within a retail store and a promotion database of product promotions associated with the products;
positioning the products for sale in the retail store;
communicating electronically with at least one consumer shopping in the retail store with a processing device of a commerce server;
detecting consumer interest in purchasing a first product with the processing device and an augmented reality device possessed by the consumer;
promoting the first product when consumer interest is detected by the processing device with one of video data and audio data communicated through the augmented reality device; and
generating, with the processing device, an invoice to the manufacturer with the processing device in response to said promoting step.

17. The method of claim 16 further comprising:
linking, with the processing device, the first product with a second product by directing two different product promotions to the at least one consumer.

18. The method of claim 17 further comprising:
promoting the second product when consumer interest in the first product is detected by the processing device with one of video data and audio data communicated through the augmented reality device; and
generating, with the processing device, an invoice to a manufacturer of the second product with the processing device in response to said step of promoting the second product.
